(19) United States
(12) Patent Application Publication
(10) Pub. No.: US 2022/0302575 A1
(43) Pub. Date: Sep. 22, 2022

(54) SYSTEM AND METHOD FOR TRANSLOCATING AND BUFFERING CELLULAR RADIATION SOURCE

(71) Applicant: GOODTECHCOM LTD., Tel Aviv (IL)

(72) Inventors: Michael BANK, Jerusalem (IL); Carmi HALACHMI, Tel Aviv (IL); Eugene SHUBOV, Modi'in (IL)

(21) Appl. No.: 17/641,687

(22) PCT Filed: Sep. 7, 2020
(86) PCT No.: PCT/IL2020/050975

§ 371 Date: Mar. 9, 2022

(30) Foreign Application Priority Data
Sep. 9, 2019 (IL) 269198

(51) Int. Cl. H01Q 1/22; H01Q 1/24; H01Q 1/52; H01Q 19/26; H02J 50/50; H04B 1/3827; H04B 7/155; H04W 16/26

(52) U.S. Cl. CPC H01Q 1/2291; H01Q 1/245; H01Q 1/525; H01Q 19/26; H02J 50/50; H04B 1/3838; H04B 7/15578; H04W 16/26; H04B 7/15571

(57) ABSTRACT

System and method for reduction of exposure to electromagnetic radiation emitted while using a communication network, wherein said electromagnetic radiation can potentially cause vulnerabilities to the human body or to the data integrity conveyed thereby by the translocating and buffering of a transceiver electromagnetic radiation signal by using an intermediary relay system or method.

### FIELD OF THE INVENTION

The present invention relates to the field of exposure reduction means to electromagnetic radiation emitted while using a communication network wherein said electromagnetic radiation can potentially cause vulnerabilities to the human body or to the data integrity conveyed thereby. More specifically, the field of the invention relates to a system and method for the translocating and buffering of a transceiver electromagnetic radiation signal by using an intermediary relay system or method.

### BACKGROUND OF THE INVENTION

The use of communication networks such as cellular networks for voice and data communications has enormously increased since the early days of cellular mobile communication networks. Cellular networks enable the use of a mobile handset (or terminal) to communicate within the network. The mobility of said transceiver devices (such as cellular portable devices) has greatly contributed to their prevalent use.

A cellular network is distributed over land areas called cells, each served by at least one fixed-location transceiver. These base stations provide the cell with the network coverage which can be used for transmission of voice, data, and other types of content. A cell occasionally uses a different set of frequencies from neighboring cells, to avoid interference and provide guaranteed quality of service (QoS) within each cell. When joined together, these cells provide radio coverage over a wide geographic area. This enables a large number of portable transceiver devices (e.g., mobile phones, tablets and laptops equipped with mobile modems, pagers, etc.) to communicate with each other and with a base transceiver station (BTS) and wired telephone lines anywhere in the network, even if some of the portable transceiver devices are moving through more than one cell during transmission.

Portable transceiver devices operating within a cellular network may use adaptive power management to correlate with the signal strength identified to be received within a cell transmission. A BTS is configured to measure the portable transceiver device transmitting power during a connection and will instruct the portable transceiver device to reduce or increase its transmitting power according to the reception quality (RXQ) and received signal strength indication (RSSI) received at the BTS. If the portable transceiver device's location will come closer to the BTS, the portable transceiver device will generally be asked to reduce its transmitting power (this is not mandatory as reception power is influenced also by other factors that introduce loss to the signal strength).

Numerous available products provide for boosting cellular signal in a given area (such as in a building, a business or a vehicle) primarily to prevent the disruption of service, i.e. to provide a reliable link, no dropped calls, consistent text messages, fast data speeds, etc. Some products, such as SureCall Fusion2Go kits and weBoost Drive Sleek Cradle Signal Booster for cars, trucks and large vehicles and Wilson Pro70 signal booster for homes and buildings, are designed to boost a weak existing cellular signal, amplify it and provide a subscriber or multiple subscribers with a strong signal. Such systems are mostly RF repeater systems as per US 2009/0066655 or US 2008/0299898 which employ active high/low amplitude signal filtering and augmentation, without change to signal frequency and ensure optimal isolation between the RF repeater antennas (for example, by placing the antennas at a significant distance from each other) in order to prevent interference and provide a smooth and constant reception of a portable transceiver device signal.

Increased RF signal strength entails numerous vulnerabilities. High energy RF is considered to have detrimental effect on proximal biological tissue. Namely, high radiation level may cause human bodily harm and considered “possibly carcinogenic”. Another vulnerability is that a strong RF signal may be carried over to unwarranted receivers who may abuse the network communication. Thus, an un-warranted strong signal may endanger the cellular network safety and integrity.

The displacement, relocation or transference of a communication network signal from a user's portable transceiver device to a relay device in order to relocate the most severe and dangerous radiation to a secondary device, which is spaced apart from the user, and specifically from the user's head, is known in the art. As suggested in US 2018/0054249, this may be obtained by communicating subscriber identification module (SIM) information from a SIM card installed in the mobile phone/device to a BTS via an auxiliary intermediary wireless connection. Such a method may include also the deactivation of the mobile device's transmitter after connecting it to the auxiliary device and connecting it via alternative communication mediums such as Bluetooth, Near Field Communication (NFC) or WiFi, the type of which may be dynamically selected and/or changed during a communication session.

The prevalent use of mobile cellular transceivers has brought users to highly rely and depend on the cellular networks data integrity. Though, as the scope of users and overall participants in the networks increases, the integrity of safety measures to protect secrecy or privacy of the conveyed information is endangered. Various methods of encryption and data protection are used to protect the data. Nevertheless, such means are administered by the cellular network providers and are not managed or controllable by the end-user. Current cellular data protection means are external to the end-users' regular use of the portable transceiver device and beyond end-user's control.

With the increasing popularity of the Internet of Things (IoT), cellular network connectivity of each device is becoming much more important. The importance of maintaining the integrity of IoT data for reasons of privacy, personal safety as well as preventing un-warranted external control, increase the need to provide end-user with control of security means on end-user's data protection rather than relinquishing it to cellular network operator or other third parties. Available solutions focus on either of: signal strength; or non-disruption of service and in any event seamlessly relying on the data communicated on the network, while neither regard issues of data integrity or its control.

It is therefore an object of the invention to provide a device and a method for the translocating and buffering of a transceiver device radiation by using an intermediary relaying system and method while enabling maintenance and feedback control of the signal communicated through the system thus mitigating innate vulnerabilities common to a communication networks and providing for gateway functionality.

### SUMMARY OF THE INVENTION

The present invention provides a device and a method for the translocating and buffering cellular radiation of a transceiver device by using an intermediary relaying system while enabling maintenance and feedback control of the signal communicated through the system, mitigating innate vulnerabilities common to communication networks and providing for gateway functionality.

The present invention enables reduction of the field of exposure to electromagnetic radiation emitted while using a communication network wherein said electromagnetic radiation can potentially adversely affect the human body or the data integrity conveyed thereby. The invention is implemented by translocating and buffering electromagnetic radiation signals emitted from a transceiver located in close proximity to a user by using an intermediary relay system or method, whereby said relay is carried out by an operational amplifier and/or a Subscriber Identification Module (SIM), a system on chip (SoC), a dual SIM device or alternative modalities.

The invention is further implemented by providing a substitution mechanism configured to enable the transfer of SIM credentials to a SIM SoC or using a dual SIM device in order to cause a reduction of the field of exposure to electromagnetic radiation emitted near a user. This may be achieved by using said SIM credentials in an intermediary relay system located at a certain distance from said user and using it to connect to the cellular network.

The present invention suggests the counterintuitive use of an amplifier in order to effectively reduce signal strength and thus decrease radiation field density in proximity to transceiver device associated with a user.

The following embodiments and aspects thereof are described and illustrated in conjunction with systems, devices and methods which are meant to be exemplary and illustrative, not limiting in scope. In various embodiments, one or more of the above-described problems have been reduced or eliminated, while other embodiments are directed to other advantages or improvements.

According to one aspect of the invention, there is provided a multi frequency signal repeater system for various wireless applications consisting at least one amplifier; a first group of antennas and a second group of antennas.

According to some embodiments, at least one antenna in each group is having the same spectrum and corresponding to at least one antenna in the other group,

According to some embodiments, at least one antenna of said first group of antennas is connected to the input of the at least one amplifier, and at least one antenna of the second group of antennas is connected to the output of the at least one amplifier wherein signals emitted from at least one antenna of the second group of antennas are received by at least one antenna of the first group of antennas and provide a dominant negative feedback to the amplifier. According to some embodiments, no intermediary electronic components or otherwise are implemented within said connection of the antenna groups to input and output of operator.

According to some embodiments, the repeater system is configured to be a portable device or configured to be a stationary device to be attached to a permanent location.

According to some embodiments, the at least one amplifier is an operational amplifier.

According to some embodiments, wherein both antenna groups operate at one single frequency band.

According to some embodiments, each antennas group includes several antennas each operating at different bandwidth that may range between 0.7 GHz-18 GHz.

According to some embodiments, at least one antenna of the second group of output antennas is connected to the output of the amplifier through a phase shifting component that may be controllable by, for example, electronic circuit control, voltage control or digital control.

According to some embodiments, the phase shifting component is an analogue phase shifter.

According to some embodiments, at least one antenna of the second group antennas has opposite polarization to that of the at least one antenna of the first group antennas and vice versa.

According to some embodiments, the correspondence of same spectrum antennas between said two groups of antennas is that the distance between said corresponding antennas substantially equals the value of the desired phase shift between the first and second groups of antennas.

According to some embodiments, at least one antenna of either first or second groups of antennas includes a back lobe reducing means.

According to some embodiments, at least one antenna of either first or second groups of antennas includes a side lobe reducing means.

According to some embodiments, at least one antenna of both groups of antennas include a back lobe reducing means.

According to some embodiments, the back lobe reducing means consists of reflectors.

According to some embodiments, the dominant negative feedback to the amplifier is conveyed by an electrical component.

According to some embodiments, a plurality of repeater systems having intercommunication capabilities among themselves, can communicate together with multiple mobile transceiver devices and multiple BTSs.

According to some embodiments, a signal received by the at least one input antenna is configured to be amplified by the at least one amplifier and be transmitted using the at least one output antenna.

According to some embodiments, the repeater system consisting of at least two amplifiers coupled in bidirectional positioning and configured to broadcast incoming and outgoing signals.

According to some embodiments, the repeater system consisting of means for filtering out undesired signals.

According to a second aspect of the invention, there is provided a multi frequency signal repeater system for various wireless applications (which may be, but not limited to, the aspect discussed above) comprising at least one repeater associated with a SIM SoC; at least one dedicated repository device associated with a transceiver device configured to contain and read a SIM card.

According to some embodiments, the SIM card contained in the dedicated repository device is configured to be substituted by transmitting its SIM card credentials to the SIM SoC associated with the repeater, wherein the repeater is configured to communicate with a cellular network instead of the transceiver device.

According to some embodiments, the SIM SoC may be replaced by a modified SIM tray or dual SIM.

According to some embodiments, upon communication of the repeater with the cellular network the transceiver device operates in a non-cellular mode.

According to some embodiments, the transceiver device further comprising a SIM SoC embedded within the dedicated repository device and associated with the transceiver device.

According to some embodiments, the dedicated repository device is configured to be placed in an outer casing of the transceiver device.

According to some embodiments, the connection between the dedicated repository device and the SIM SoC associated with the transceiver device is performed through a short distance radio connection protocol.

According to some embodiments, the connection between the dedicated repository device and the SIM SoC associated with the transceiver device is performed through a wired connection.

According to some embodiments, the connection between the dedicated repository device associated with a transceiver device and the SIM SoC associated with the repeater is performed through a short distance radio connection protocol.

According to a third aspect of the invention, there is provided a method for reducing cellular radiation in proximity to a user, to reduce its detrimental effect to user's body and organs, comprising the steps of transmitting an analogue signal from at least one output antenna of the repeater system; receiving the transmitted analogue signal with at least one input antenna of the repeater system, wherein said received analogue signal represents a fraction of the analogue signal transmitted through the at least one output antenna and providing a dominant negative-feedback to at least one amplifier of the repeater system.

According to some embodiments, the at least one amplifier is an operational amplifier or may be a non-inverting amplifier having both input and output antenna radiate signals with opposite polarities or may be a non-inverting amplifier having both input and output antenna radiate signals with the same polarities.

According to some embodiments, the at least one input and output antennas are operating at one single frequency band.

According to some embodiments, the at least two input antennas operating at different bandwidth.

According to some embodiments, the correspondence of same bandwidth antennas between said output and input antennas is that the distance between said corresponding antennas substantially equals the value of the desired phase shift between the at least one input and output antennas.

According to some embodiments, a signal received by the at least one input antenna is configured to be amplified by the at least one amplifier and be transmitted using the at least one output antenna.

According to a fourth aspect of the invention, there is provided a method for reducing high-gain cellular radiation in proximity to a user comprising the steps of substituting a SIM card contained in a dedicated repository device by transmitting its SIM card credentials to a SIM SoC associated with a repeater; connecting to a cellular network using the SIM SoC associated with the repeater and entering into a transceiver device's non-cellular mode.

According to some embodiments, the communication between the dedicated repository device and the SIM SoC associated with the repeater is performed through a short distance radio connection protocol.

According to some embodiments, a further SIM SoC is associated with the transceiver device and communication between said further SIM SoC and the dedicated repository device is performed through a short distance radio connection protocol or through a wired connection.

According to some embodiments, a further SIM SoC is associated with the transceiver device and communication between said further SIM SoC and the SIM SoC associated with a repeater is performed through a short distance radio connection protocol or through a wired connection.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

In the Figures:

FIG. 1A constitutes a schematic view of a multi frequency signal repeater system, according to some embodiments.

FIG. 1B constitutes a schematic view of a multi frequency signal repeater system, according to some embodiments.

FIG. 1C constitutes a schematic view of a multi frequency signal repeater system, according to some embodiments.

FIG. 2 constitutes a schematic view of a multi frequency signal repeater system, according to some embodiments.

FIG. 3 constitutes a schematic view of a multi frequency signal repeater system, according to some embodiments.

FIG. 4 constitutes a schematic view of a multi frequency signal repeater system antenna arrangement, according to some embodiments.

FIG. 5 constitutes a schematic view of a multi frequency signal repeater system, according to some embodiments.

FIG. 6 constitutes a schematic view of a multi frequency signal repeater system, according to some embodiments.

FIG. 7 constitutes a wiring diagram of a multi frequency signal repeater system, according to some embodiments.

FIG. 8 constitutes a schematic view of a multi frequency signal repeater system, according to some embodiments.

FIG. 9 constitutes a schematic view of an experiment apparatus used to present enablement of some embodiments.

FIG. 10 constitutes a schematic view of a multi frequency signal repeater system home installation, according to some embodiments.

FIG. 11 constitutes a schematic view of a multi frequency signal repeater system automobile installation, according to some embodiments.

FIG. 12 constitutes a schematic view of a SIM SoC installation, according to some embodiments.

FIGS. 13A and 13B constitute schematic views of a modified SIM card tray assembly, according to some embodiments.

FIG. 14 constitutes a schematic view of a dedicated software operation.

### DETAILED DESCRIPTION AND EXEMPLARY EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, “setting”, “receiving”, or the like, may refer to operation(s) and/or process(es) of a controller, a computer, a computing platform, a computing system, or other electronic computing device, that manipulates and/or transforms data represented as physical (e.g., electronic) quantities within the computer's registers and/or memories into other data similarly represented as physical quantities within the computer's or central processing unit's registers and/or memories or other information non-transitory storage mediums that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

The term “transceiver device”, as used herein, refers to any device that is configured to transmit and receive packets of data such as, for example, mobile phones, tablets, laptops, pagers, devices equipped with mobile broadband modems, etc.

The term “server”, as used herein, refers to a transceiver device having a SIM access server with direct access to a subscription module that acts as a SIM card reader, which assists the client in accessing and controlling the subscription module via a low frequency or low energy communication means such as, for example, a Bluetooth link.

The term “client”, as used herein, refers to a repeater system having a SIM access server connected via a connection link via a low frequency or low energy communication means such as, for example, a Bluetooth link or other low power wide area network (commonly known as LPWAN) to the SIM access server. The client accesses and controls the subscription module inside the server via said exemplary Bluetooth link.

The term “client server”, as used herein, refers to a popular model for networking that utilizes both client hardware devices and servers, each with specific functions. The client server model can be used on the Internet as well as on local area networks (LANs). Examples of client-server systems on the Internet include web browsers and web servers, FTP clients and servers, and the DNS.

The term “negative feedback”, as used herein, refers to an amplifier that subtracts a fraction of its output from its input, so that negative feedback opposes the original signal. The applied negative feedback can improve amplifier's or overall repeater's performance (gain stability, linearity, frequency response, step response) and reduce sensitivity to parameter variations due to manufacturing or the environment.

The terms “dominant negative feedback would include, but not limited to, also a dominant negative feedback whereby the feedback loop becomes the dominant feedback mechanism applied to the amplifier, hence reducing any other feedback mechanism which would otherwise adversely affect the overall operation of the system which includes the feedbacked amplifier and in effect reduce the system's signal output.

The term “routing CPU”, as used herein, refers to a networking device that forwards and analyzes data packets between computer networks. A routing CPU may be found in a router connected to two or more data lines from different networks.

The term “SIM access profile (SAP)”, as used herein, refers to a technology which enables a local device to access a remote SIM card through a communication means such as a Bluetooth link and by doing so enable remote use of the SIM card.

The term “virtual SIM”, as used herein, describes a technology wherein a transceiver device serves as a virtual SIM server while a repeater system serves as a virtual SIM client. The virtual SIM server will transfer the SIM data to the virtual SIM client, which in turn uses the SIM data to register to a communication network.

The term “electronic SIM”, as used herein, refers to a permanent and unreplaceable SIM card comprised in a transceiver device. The SIM stores all information that is necessary to identify and authenticate a mobile subscriber. This term may also describe a technology wherein a repeater system acquires an actual SIM profile directly from the transceiver device wherein the repeater system mimics the network provider by downloading the electronic SIM profile from the transceiver device.

The term “remote SIM access profile (rSAP)”, as used herein, refers to a profile designed for handsfree (HF) transceiver device operation (such as Bluetooth) which was originally designed for cellular communication with end-users travelling in in vehicles. A vehicle having rSAP capabilities would have a built-in mobile phone device which connects to an external antenna mounted on the vehicle effectively having the vehicle systems operate as a whole as a transceiver device instead of end-user's portable transceiver device whereby end-user's SAP is remotely accessed via LPWAN means. In other words, instead of using a separate SIM card, the car borrows the mobile's card over a LPWAN connection such as a Bluetooth connection.

The term “Duplicated SIM”, as used herein, describes a technology wherein a SIM reader device can get all the data from a SIM and clone it. For example, a user can insert the original SIM card to a dedicated slot in a repeater system that contains a rewritable SIM card. Once the user will insert the SIM card and activate the cloning procedure, the repeater system will copy all needed data form the original SIM to the rewritable SIM. Once the operation is done the user can take back the SIM card and place it in the transceiver device. As a result, once the transceiver device connects to the repeater system the user's transceiver device will enter a mode similar to airplane mode, to make sure both devices will not work simultaneously.

The term “dual SIM”, as used herein, describes an approach wherein a cellular network allows the sharing of same user identification data (such as cellular number) between two or more devices. The approach is enabled by means of SIM remote provisioning utilizing either eSIM or iSIM technology. Some examples for “dual SIM” usage may be found in systems such as the Apple Watch Series 4 and Google Smartwatches, wherein the watches use the same cellular number as that used in a primary transceiver device (e.g. a cellular device owned by the same user as that of the watch). Where dual SIM is used, both a primary cellular transceiver device and a smartwatch can be used for establishing outgoing calls and receiving incoming calls. For example, in case that a Smartwatch associated with a cellular device accepts an incoming call, the same incoming call to the primary cellular phone may be disconnected by the cellular network.

The term “Voice over WiFi (Wifi Calling)”, as used herein, describes a technology wherein vocal conversations can be transmitted over a wireless broadband network.

The term “controller”, as used herein, refers to any type of computing platform that may be provisioned with a memory device, a Central Processing Unit (CPU) or microprocessor device, and several input/output (I/O) ports, such as, for example, a general-purpose computer such as a personal, laptop or a tablet computer, a smartphone device or a cloud computing system.

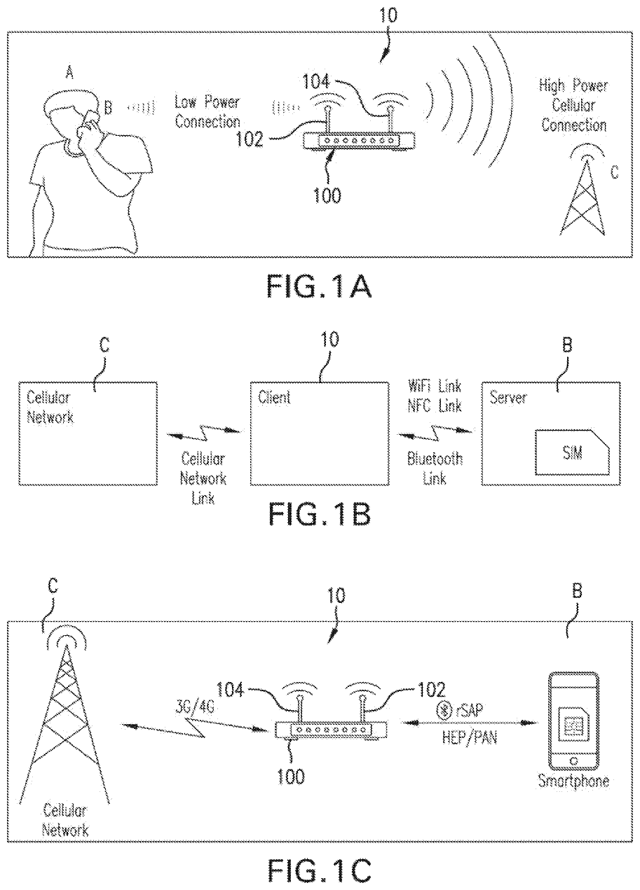

Reference is made to FIG. 1A which constitutes a schematic view of a multi frequency signal repeater system 10 (hereinafter referred to as “repeater system 10”) operated as an intermediary relay and gateway repeater and provided for the translocating and buffering of a transceiver devices B's electromagnetic radiation in order to control rate of radiation in a given space and thus reduce the amount of radiation absorbed by a user A's body. According to some embodiments of the invention. As shown, repeater system 10 comprises an amplifier 100, a first group of antenna 102 (hereinafter referred to as “antenna 102”) and a second group of antenna 104 (hereinafter referred to as “antenna 104”). According to some embodiments, antenna 102 is an input antenna and antenna 104 is an output antenna. According to some embodiments, antenna 102 has opposite polarization to that of antenna 104. According to some embodiments, multi frequency directional signal repeater system 10 may comprise more than one antenna 102 and more than one antenna 104.

According to some embodiments, repeater system 10 is configured to interact with a cellular network C on one hand, and with a transceiver device B (that can be, for example, a cellular phone, a tablet, a PC, etc.) operated by at least one user A, on the other hand. According to some embodiments, repeater system 10 is configured to connect to cellular network C using a standard cellular communication protocol while communicating with transceiver device B using a low power or a low radiation protocol (such as Bluetooth, WIFI, Near Field Communication (NFC), etc.). According to some embodiments, amplifier 100 can be an operational amplifier (OA) such as an electromagnetic operational amplifier or other amplifiers which may also or alternatively be non-inverting amplifiers. According to some embodiments, transceiver device B comprises adapting capabilities providing for varying levels of output signal according to predetermined situations.

Reference is made to FIG. 1B, which constitutes a schematic view of a repeater system 10, according to some embodiments of the invention. As shown, repeater system 10 can also be described as part of a client-server model, wherein the client is repeater system 10, which connects to transceiver device B that functions as a server. According to some embodiments, the connection between repeater system 10 and transceiver device B is carried out by a low power or a low radiation protocol such as Bluetooth, WIFI, NFC etc. communication protocols. According to some embodiments, the connection between repeater system 10 and cellular network C is carried out by a standard cellular network communication protocol.

Reference is made to FIG. 1C, which constitutes a schematic perspective view of a repeater system 10, according to some embodiments of the invention. As shown, repeater system 10 comprises an amplifier 100, a first group of antenna 102 and a second group of antenna 104. According to some embodiments, repeater system 10 connects with transceiver device B (that can be, for example, a cellular phone such as a smartphone) via a Bluetooth remote SIM access profile (rSAP) connection protocol and, in turn, repeater system 10 connects to the cellular network C through a standard cellular communication protocol. According to some embodiments, multi frequency directional signal repeater system 10 may comprise more than one antenna 102 and more than one antenna 104.

According to some embodiments, during network connection establishment phase, repeater system 10 acts as an rSAP client and transceiver device B as an rSAP server. According to some embodiments, after the cellular communication is established, repeater system 10 switches either to handsfree (HF) or Personal Area Network (PAN) Bluetooth profiles.

According to some embodiments, a designated software is run by transceiver device B and comprises a dialer and a cellular connection tracking service configured to monitor the current cellular connection status and switch between LPWAN profiles, such as Bluetooth profiles, accordingly.

According to some embodiments, transceiver device B's user experience (UX) is kept normal and the transceiver device B operates as a remote modem for accessing a cellular network. According to some embodiments, (such as the use of repeater system 10 embedded in a vehicle), transceiver device B operates as a remote SIM card holder for the built-in repeater system 10.

According to some embodiments, transceiver device B can communicate with repeater system 10 using a standard cellular communication protocol and comprises adapting capabilities for varying levels of signal output according to predetermined situations, for example, transceiver device B located in close proximity to repeater system 10 can communicate with it using a low strength standard cellular communication protocol while repeater system 10 communicates with a cellular network C using the same cellular communication protocol but with a higher gain. As a result, a reduction in the amount of radiation absorbed by a user's A body (shown in FIG. 1A) is achieved.

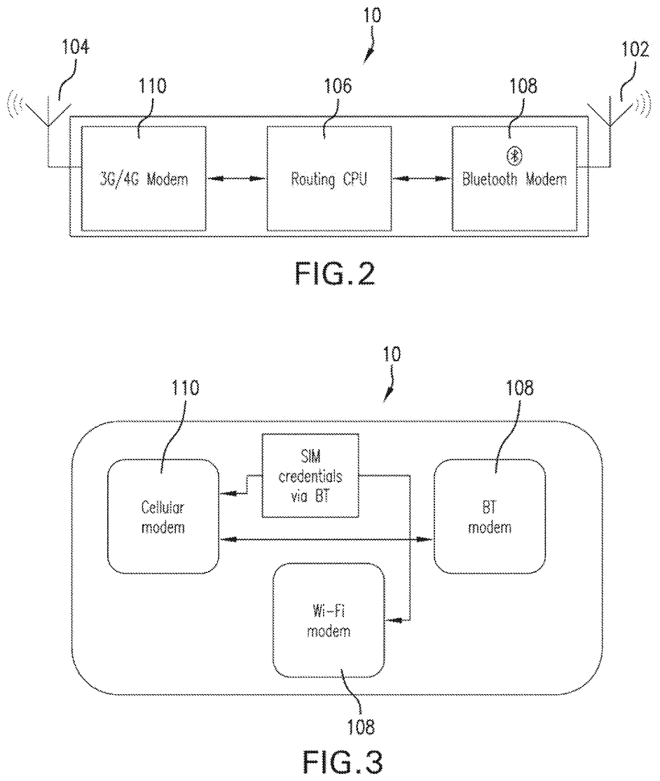

Reference is made to FIGS. 2 and 3, which constitute a schematic view of a repeater system 10, according to some embodiments of the invention. As shown, repeater system 10 comprises a routing CPU 106 which simultaneously connects between a low power or a low radiation modem 108 such as, for example, a Bluetooth, NFC or a WIFI modem, and a cellular modem 110 such as, for example, a 2G to 5G cellular modem.

According to some embodiments, repeater system 10 allows an end user to be exposed to a low radiation while using a transceiver device B. Said low exposure is achieved by using the high-power cellular modem 110 embedded in repeater system 10 in order to connect to the cellular network C instead of using the high-power cellular modem of the transceiver device B located in close proximity to the user A (shown in FIG. 1A). As a consequence, the cellular communication that has a potential to emit strong radiation is carried out between the repeater system 10 and the cellular network C, while the transceiver device B communicates with the repeater system 10 using an LPWAN protocol (such as, for example, a Bluetooth, WIFI, NFC etc.).

According to some embodiments, the repeater system 10 does not necessarily require a separate SIM card to sign in to cellular network C. Several technologies can be used in order to represent a SIM card in repeater system 10, for example, a Virtual SIM technology, wherein the original transceiver device B serves as the virtual SIM server, while the repeater system 10 serves as the virtual SIM client. The virtual SIM server will transfer the SIM data to the virtual SIM client, that in turn will use the SIM data and register a connection with the cellular network C. From this point and on, repeater system 10 (now serving as a client) is operating as a transceiver device as if the actual SIM card from the transceiver device B (now serving as a server) is used therewith.

According to some embodiments, when the repeater system 10 operates without a separate SIM card, it may take advantage of alternative approaches to transfer SIM card credentials from transceiver device B, such as, for example, Virtual SIM, Bluetooth rSAP profile, etc.

According to some embodiments, after transferring the SIM card credentials from transceiver device B to repeater system 10, transceiver device B can enter into a low-power mode (such as, for example, a “flight mode”). In this mode the cellular modem of transceiver device B will be shut down and cellular communication will be carried out using the cellular modem of repeater system 10. Once the connection to the repeater system 10 is ceased, transceiver device B will return to its normal mode of operation.

According to some embodiments, repeater system 10 comprises a Bluetooth-to-Cellular Gateway (hereinafter referred to as BT4G GW) technology. The reduction of radiation exposure to user A is achieved by operating a high-power cellular modem from the BT4G GW of repeater system 10, hence, high radiation cellular transmission is established between the BT4G GW and the cellular network C instead of between the transceiver device B and the cellular network C.

According to some embodiments, repeater system 10 comprises a dedicated WiFi modem that allows high speed data transfer so that the user will be able to have the same data service capabilities as if he is solely using transceiver device B.

According to some embodiments, repeater system 10 does not comprise any user input-output means (I/O), instead, repeater system 10 solely acts as a remote cellular modem that uses transceiver device B's SIM credentials while all the I/O operation is done by user's A manipulation of transceiver device B. According to some embodiments, repeater system 10 can provide user A with various communication services, such as calls, data transfer, VOIP (VoLTE, ViLTE), etc.

According to some embodiments, one repeater system 10 can serve several transceiver devices B while providing all users A the same seamless experience of connecting and using the cellular network C without interference.

According to some embodiments, repeater system 10 can be either a portable device (carry-on device) or stationary device configured to be attached to a permanent location.

According to some embodiments, repeater system 10 can be an already existing consumer device that comprises cellular connection means (for example: a PC, a laptop, a tablet, a smartphone, home/car infotainment system, etc.), in this case the consumer device will work as described above with dedicated firmware and software.

According to some embodiments, the dedicated software operating on transceiver device B comprises a dialer and a cellular connection tracking service used to monitor the ongoing status of the cellular communication and determining when to switch to or between LPWAN profiles. According to some embodiments, the said dedicated software can operate on end-user transceiver device B which comprises a dialer and a cellular connection tracking service used to monitor the ongoing status of the cellular communication and determining when to switch to or between LPWAN profiles.

According to some embodiments, while in dual SIM mode both transceiver device B and repeater system 10 receive an incoming call, the dedicated software can prevent the end-user transceiver from answering the incoming call whereby the transceiver device B sends over an LPWAN connection, such as Bluetooth, a command to the repeater system 10 to answer the call instead of answering it directly by transceiver device B. When the repeater system 10 answers the call, the primary call to the transceiver device B is automatically disconnected. All further communication between transceiver device B and repeater system 10 is via Bluetooth and repeater system 10 communicates with cellular network C.

According to some embodiments, repeater system 10 can control the data communicated with and through transceiver device B by performing firewall type operations in accordance with predefined input and output data integrity rules. To such end, repeater system 10 may provide a gateway system controlling the transceiving capabilities of repeater system 10 while allowing operations within a controlled perimeter and not enabling to communicate with a cellular network other than through said gateway and/or prevent communication of pre-defined types of data or malware. Such control may also be achieved by a digital control of transceiver device B.

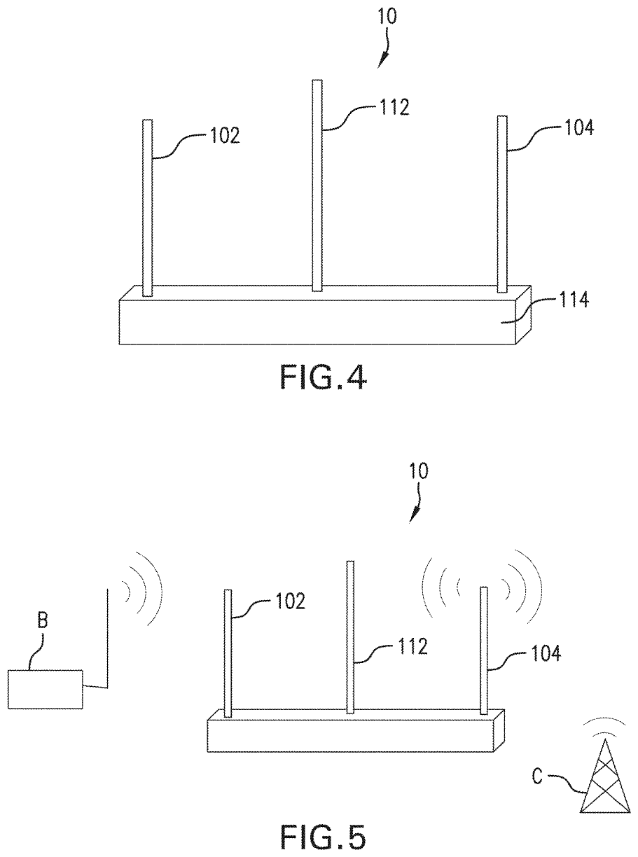

Reference is made to FIGS. 4 and 5, which constitute a general view of a repeater system 10 according to some embodiments of the invention. As shown, repeater system 10 comprises at least two antennas facing opposite directions—a first antenna 102 and a second antenna 104. According to some embodiments, antenna 102 is an input antenna configured to interact with transceiver device B of user A and antenna 104 is an output antenna configured to interact cellular network C.

According to some embodiments, a negative feedback mechanism is used to provide a reference to amplifier 100 in order to improve its performance and enable a regulation regarding a desired output. According to some embodiments, the feedback mechanism can be a deep negative feedback mechanism used to provide a reference to an operational amplifier (OA) 100 and further configured to conduct aforementioned regulation circuit. According to some embodiments, said deep negative feedback mechanism can be used in order to reduce the parasitic feedback which occurs between input antenna 102 and output antenna 104. Said reduction is enabled since the deep feedback mechanism masks the weaker peripheral parasitic feedback and eliminates its influence.

According to some embodiments, when an operational amplifier 100 comprises a deep negative feedback mechanism used as part of repeater system 10, feedback control may be obtained either by an analogue mechanism (for example, as part of an OA) that can manipulate the internally broadcasted signal or by a feedback electronic circuit, hence, digital control mechanism performed by the repeater system 10 or by transceiver device B. According to some embodiments, a deep negative feedback may be obtained by installing resistors on the input and output connections of the OA. According to some embodiments, a deep negative feedback may be obtained by installing corresponding antenna 102 and 104 instead of or in addition to said resistors or other feedback electronic circuit.

According to some embodiments, at least one back lobe reducing means 112 is placed between antennas 102 and 104 and configured to reduce back lobe radiation emitted from each antenna. According to some embodiments, back lobe reducing means 112 can be a reflector comprised of a surface made from a high impedance material such as, for example, any material, natural or artificial, that bears some degree of resistance to electric current. According to some embodiments, the at least one reflector can comprise a parabolic or sail-like surface configured to provide an efficient barrier to possible back lobe radiation emitted from each antenna groups 102 or 104. According to some embodiments, said lobe reducing means 112 features can be slightly higher than a quarter wavelength in a low frequency.

According to some embodiments, back lobe reducing means 112 has an influence on the operation of antenna groups 102 or 104, similar to the reflector used on Udo-Yagi type antennas.

According to some embodiments, transceiver device B is configured to emit a low power or a low radiation transmission (in a LPWAN protocol such as Bluetooth, WIFI, NFC etc.), said transmission is then received by input antenna 102 and amplified by amplifier 100. Said amplified transmission is then transmitted using output antenna 104 using a standard communication protocol such as, for example, a cellular communication protocol. According to some embodiments, back lobe reducing means 112 blocks or reduces the parasitic back radiation emitted from output antenna 104.

According to some embodiments, enclosure 114 is provided and configured to accommodate amplifier 100 and first and second antenna groups 102 and 104. Said enclosure can be, for example, a case in any form or shape and configured to contain any component comprising repeater system 10.

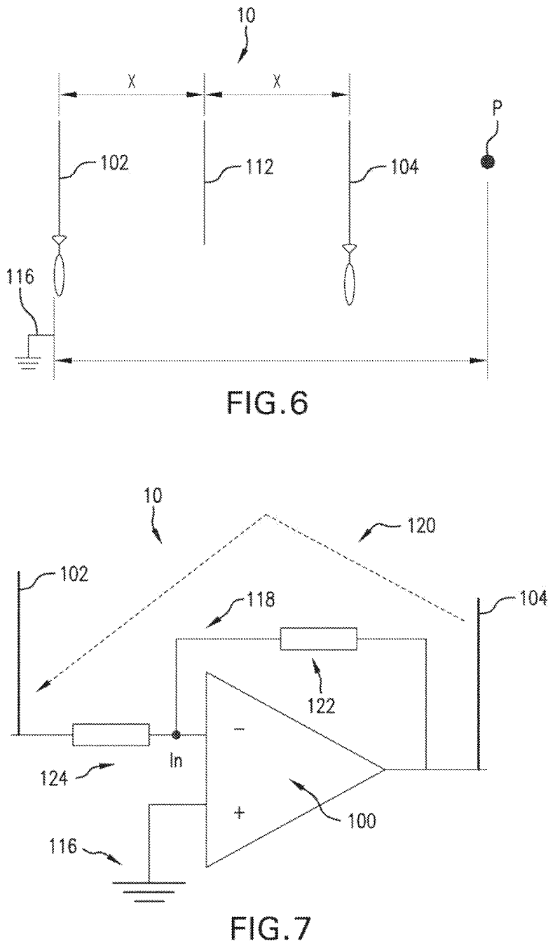

Reference is made to FIG. 6, which constitutes a schematic perspective view of a repeater system 10, according to some embodiments of the invention. As shown, repeater system 10 comprises an input antenna 102 and an output antenna 104 while at least one back lobe reducing means 112 is placed between said antennas. The distance X between the input antenna 102 and the lobe reducing means 112 is equal to the distance X between the lobe reducing means 112 and the output antenna 104. Neutral sinking line 116 that can be, for example, an earthing line or any electrical grounding mechanism is configured to absorb and drain excess electrical charge and may be materialized by various means and methods such as a voltage nullifier, a ground plane, a nullifying circuit, etc. According to some embodiments, repeater system 10 comprises a regular amplifier 100 (not shown). Experiments conducted by measuring the gain of the second antenna 104 while using the above configuration revealed that placing the lobe reducing means 112 at exactly halfway distance between said input and output antennas increases the gain of repeater system 10 by considerable amount.

Reference is made to FIG. 7, which constitutes a wiring diagram of repeater system 10, according to some embodiments of the invention. As shown, repeater system 10 comprises an operational amplifier (OA) 100 that comprises a deep negative feedback mechanism. Negative feedback line 118 configured to provide negative feedback in order to monitor and control the signal transmitted by output antenna 104. Said negative feedback line 118 can use either an analogue or a digital mechanism in order to monitor said transmitter signal. Parasitic feedback 120 emitted from output antenna 104 has a back lobe that can potentially affect input antenna 102. Resistors 122 and 124 are placed along the negative feedback line 118 and configured to reduce the feedback signal in accordance with regulation and control needs. According to some embodiments, resistors 122 and 124 can be analogue resistors or digital resistors (commonly referred to as digital potentiometer or digipot). Neutral sinking line 116 that can be, for example, an earthing line or any electrical grounding mechanism is configured to absorb and drain excess electrical charge and may be materialized by various means and methods such as a voltage nullifier, a ground plane or a nullifying circuit.

According to some embodiments, input and output antennas 102 and 104 are monopoles and configured such that their height equals the quarter wavelength of a low frequency. According to some embodiments, negative feedback line 118 rely on the ratio between resistors 122 and 124. According to some embodiments, parasitic feedback is not a deep feedback since an OA amplifier has a zero potential at its “In” point. In order to further reduce the parasitic feedback, lobe reducing means 112 (not shown), such as a reflector can be added while, according to some embodiments, said lobe reducing means 112 can be slightly higher than a quarter wavelength in a low frequency.

According to some embodiments, at least one output antenna 104 is connected to the amplifier 100 through a phase shifting component (not shown), configured to provide an output signal with an equal amplitude as the input signal. According to some embodiments, said phase shifting component can be a variably controlled electronic circuit device that is a digital phase shifter configured to be programmable and controlled by a controller. According to some embodiments, said phase shifting component can be an analogue phase shifter and be controlled, for example, by a voltage level, wherein the phase shift change is based on tuning a desired voltage level. According to some embodiments, said phase shifting component can be a mechanical phase shifter wherein a desired phase shift is controlled and adjusted manually, for example, using a turntable knob.

According to some embodiments, at least one antenna of a first group of antennas 102 has the same bandwidth (or spectrum) and corresponds to at least one antenna of the second group of antennas 104. According to some embodiments, said correspondence occurs when the distance between at least two antennas of either groups 102 or 104 substantially equals the value of the desired phase shift between first and second groups of antennas 102 and 104.

According to some embodiments, each antenna group includes several antennas of various band width. According to some embodiments, the band width of each antenna in either groups of antennas 102 or 104 can be between 0.7 GHz and 18 GHz. According to some embodiments, the band width of each antenna in either groups of antennas 102 or 104 can be between 0.7 GHz and 60 GHz.

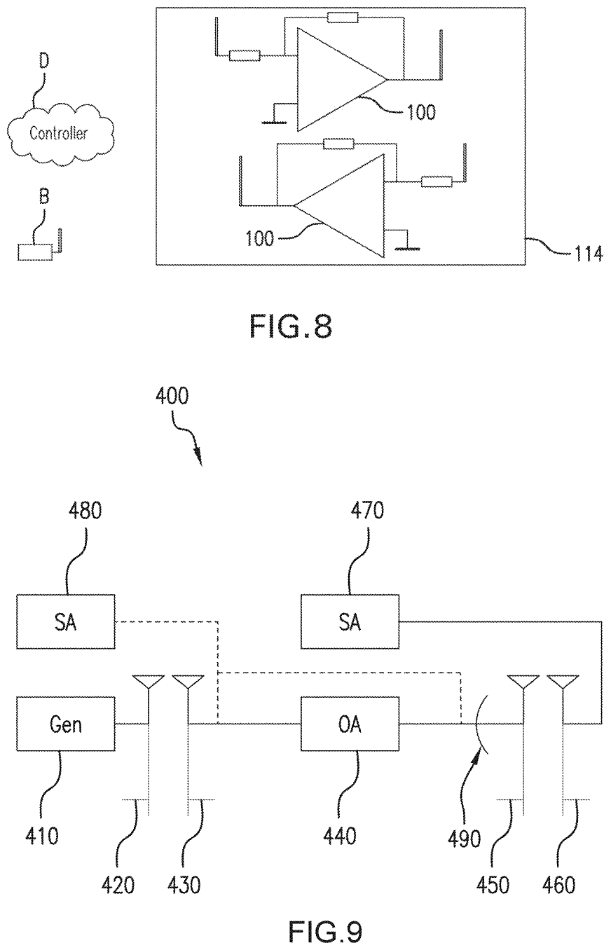

Reference is made to FIG. 8, which constitute a schematic view of repeater system 10, according to some embodiments of the invention. As shown, at least two amplifiers 100 and their associated antenna groups are packed within enclosure 114 and placed in an opposite position in order to receive and transmit RF radiation in different directions. According to some embodiments, a bidirectional positioning of amplifiers 100 prevents internal input and output wave interference by coordinating incoming and outgoing broadcast in the vicinity of the perimeter of the system's operation range (enabling full duplex operation through the system).

According to some embodiments, controller D alternately controls said amplifiers 100 in order to prevent a possible interference by, for example, determining when to operate each amplifier in accordance with the operation of transceiver device B. for Example, when transceiver device B transmits a signal, controller D may determine to switch on particular amplifier 100 that its input antenna faces toward transceiver device B and its output antenna faces outward and away from transceiver device B, and by that to avoid interference with ingoing and outgoing signals and vice versa.

According to some embodiments, controller D can be integrated within repeater system 10. According to some embodiments, controller D can be located outside repeater system 10, for example, controller D can be a separated controller placed in proximity to repeater system 10 and communicates with it. According to some embodiments, controller D can be integrated within transceiver device B, for example, a mobile smartphone can execute a software configured to control the multiple amplifiers of repeater system 10 with regard to optimizing communication and preventing interferences. According to some embodiments, controller D can be a cloud computing service that can provide on-demand availability of computer system resources in order to optimize communication and prevent interferences.

According to some embodiments, a plurality of repeater systems 10 having intercommunication capabilities among themselves that can communicate together with multiple transceiver devices B and multiple BTSs thus creating a sub-network of communication.

According to some embodiments, transceiver device B can comprise an adaptable power management means in order to lower and prevent surges in the long-term excessive signal transmissions, thus prolonging end-device battery life while operating with repeater system 10. According to some embodiments, transceiver device B can operate within radiation rates predefined by insurance policy requirements.

Reference is made to FIG. 9 whereby an experiment apparatus 400 is presented by way of an un-limiting example. According to some embodiments, signal generator 410 (that can be, for example, a mobile phone) communicates by antenna 420 to first input group antenna 430. Antennas 420 and 430 are positioned at a predetermined spacing (in said experiment apparatus 400, the distance between the two antennas 420 and 430 is 6 centimeters). Antenna 430 is connected to an input port of an operational amplifier (OA) 440. Antenna 450 is connected to an output port of said OA. Antenna 450 is positioned in relation to antenna 460 (that can be, for example, a standard log periodic antenna) at a predetermined spacing that is identical to the spacing between antennas 420 and 430. For the sake of the experiment, antennas 420, 430, 450 and 460 are identical (type, bandwidth, etc.). Input and output signals of the OA 440 were monitored by spectral analyzers 470 and 480. As presented in Table 1, a generated signal of −20 dBm produced by signal generator 410 was modified by use of a feedbacked OA 440 to a level of −77 dBm and −62 dBm with a reflector 490 operating as a back lobe reduction means.

TABLE 1

| | Ant. 1 (signal | | | |
|---|---|---|---|---|
| | Generator, | | | |
| | frequency = 650 MHz) | Ant. 2 | Ant. 3 | Ant. 4 |
| OA Off | −20 dBm | −76 dBm | −70 dBm | −83 dBm |
| OA On | −20 dBm | −76 dBm | −61 dBm | −77 dBm |
| OA On + | −20 dBm | −76 dBm | −53 dBm | −62 dBm |
| Reflector | | | | |

According to some embodiments, antennas 420, 430, 450 or 460 of experiment apparatus 400 comprises a design enabling transmitting/receiving signals in various frequencies, eliminating the need to change antennas accordingly. According to some embodiments, antennas 420, 430, 450 or 460 do not require grounding.

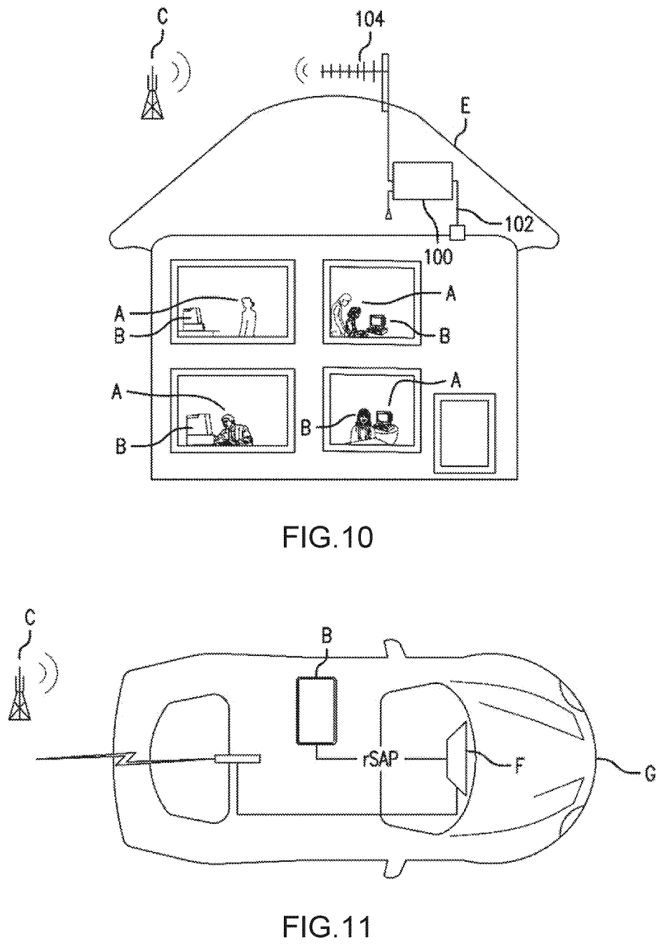

Reference is made to FIG. 10, which constitutes a schematic view of repeater system 10, according to some embodiments of the invention. As shown, signal repeater system 10 can be installed in building E. Multiple users A can be located within various spaces within building E while each of said users A can be connected to communication network C using multiple personal transceiver devices B. According to some embodiments, repeater system 10 is configured to interact with the cellular network C on one hand and with multiple transceiver devices B on the other hand. According to some embodiments, repeater system 10 is configured to connect to the communication network C (that can be, for example, a cellular network) using a standard cellular communication protocol while the communication with transceiver devices B is conducted using a LPNAW or low radiation protocol (such as Bluetooth, WIFI, NFC etc.) and as a result, reduces the users A's radiation exposure. According to some embodiments, at least one input antenna 102 is facing toward the spaces of building E and configured to receive transmissions from multiple transceiver devices B, amplifying the signal using amplifier 100 and transmitting it through at least one output antenna 104 facing outward toward communication network C.

Reference is made to FIG. 11, which constitutes a schematic view of repeater system 10, according to some embodiments of the invention. As shown, transceiver device B can operate as a SIM card holder and connect to a communication network C via a built-in mobile transceiver device F of a car G. According to some embodiments, built-in mobile transceiver device F can be a built-in mobile phone configured to connect to a cellular network C without a dedicated SIM card. According to some embodiments, said connection between transceiver device B and built-in mobile transceiver device F is carried out by using an rSAP Bluetooth profile.

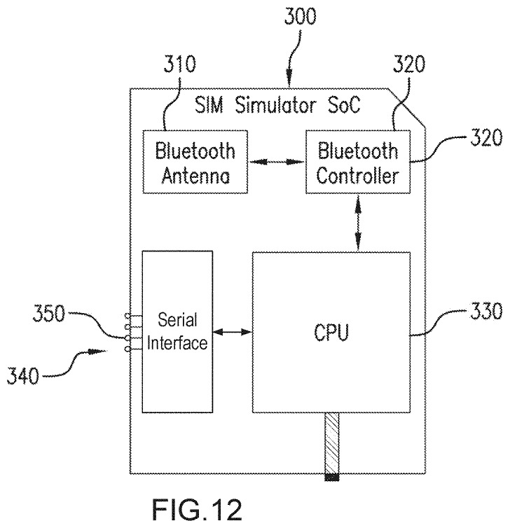

Reference is made to FIG. 12, which constitutes a schematic view of SIM system on chip (SoC) 300, according to some embodiments of the invention. As shown, a duplicated SIM may be attained by substituting the end-user's SIM card with a SIM SoC 300 configured to be located inside transceiver device B, whereas the original SIM card is deposited for term of use within the system in a dedicated repository device which, according to some embodiments, may be included in the transceiver device B's physical casing or enveloping. According to some embodiments, the original SIM card of which a duplicated SIM was made, may be plugged, using the dedicated repository device, into an input/output port of transceiver device B that may be a USB port. According to some embodiments, SIM SoC 300 is in the form of a SIM card (for example, micro or nano SIM card). According to some embodiments, SIM SoC 300 comprises a built-in routing CPU 330, an embedded low-power wide-area network (LPWAN) modem such as a Bluetooth modem (comprising of an antenna 310 and a controller 320) and a serial line interface 340 coupled with a serial modem 350. According to some embodiments, the SIM SoC 300 also configured to be located inside or upon repeater 10.

According to some embodiments, when the repeater 10 is not paired with transceiver device B, the dedicated repository device comprising the original SIM will read and forward SIM data to the SIM SoC 300 embedded within transceiver device B using a low radiation connection protocol such as Bluetooth and transceiver device B will communicate with the cellular network C by transmitting high-gain cellular radiation.

According to some embodiments, when repeater 10 is paired with transceiver device B, the dedicated repository device comprising the original SIM will read and forward SIM data to the SIM SoC 300 embedded within transceiver device B using a low radiation connection protocol such as Bluetooth. The pairing mode will also cause transceiver device B to enter a non-cellular mode (such as an airplane mode) and will cause transceiver device B to communicate with repeater 10 using a low radiation protocol such as Bluetooth. During this mode, repeater 10 actively connects to the cellular network C by transmitting high-gain cellular radiation while using its embedded SoC 300 and SIM credentials of transceiver device B.

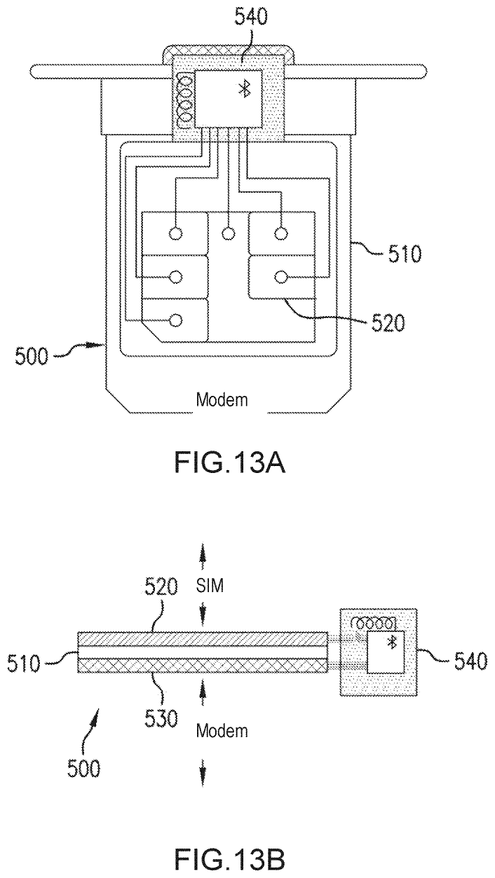

Reference is made to FIGS. 13A and 13B, which constitutes a schematic view of a modified SIM card tray 500 assembly, according to some embodiments of the invention. Commonly, SIM card tray 510 is characterized by having a SIM chip embedded on one of its faces, while the other face of SIM card tray 510 remains blank. According to some embodiments, modified SIM card tray assembly 500 includes several layers which may include regular SIM chip layer 520, SoC layer 530 (which may include LPWA means such as SoC 540) and a SIM card tray polymeric substrate 510. The coupling of the several layers may be obtained by using common adhesive materials. According to some embodiments, the blank face of SIM card tray 510 is modified by applying to it SoC 540 (similar in features to previously disclosed SoC 300) which can communicate via LPWAN means while the repeater 10 (not shown) is identified in the area of transceiver device B. Modified SIM card tray assembly 500 may include a switching means controllable by SoC 540 to enable regular SIM card communication while no transceiver device B is presently in area of repeater 10.

According to some embodiments, repeater 10's gateway operates under a dedicated program that enables handling outgoing and incoming calls in accordance with the radiation reduction requirements of the system. For instance, for outgoing calls, the said program enables repeater 10's gateway functionality to convey call initiated by end user transceiver device operating as a headset and dialer, whereas in case of incoming calls, instead of the end user transceiver device B answering an incoming call, the program instructs repeater 10's gateway functionality to answer the call and convey call data to end user transceiver device B operating as headset at reduced signal magnitudes.

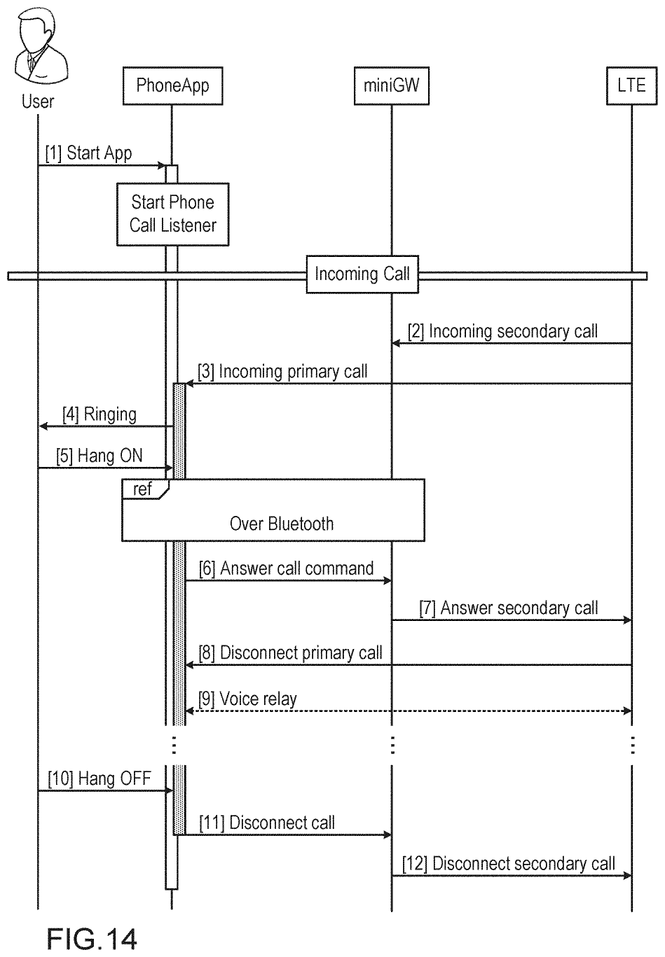

Reference is made to FIG. 14, which constitutes a schematic view of a dedicated software operation with a dual SIM exemplifying, without limitation, steps of incoming call handling by repeater system 10 which by implementing a dedicated software (“PhoneApp”) “answers” a cellular incoming call instead of end-user transceiver (“Phone”), involving the following steps: [1] user initiates operation of the “PhoneApp” on the end-user transceiver or that “PhoneApp” automatically initiated upon during end-user transceiver boot. During initiation, the “PhoneApp” establishes a “Phone Call Listener” service which identifies (“Listens”) the occurrence of incoming calls; [2] gateway (“miniGW”) receives the incoming secondary call but still doesn't answer; [3] “Phone Call Listener” service is also notified of the primary incoming call; [4] “Phone Call Listener” service instigates end-user transceiver to ring and inform user of there being an incoming call; [5] user decides to answer the call and presses the “Hang ON” button on the “PhoneApp” use interface; [6] the “PhoneApp” conveys an “Answer call” command to gateway via Bluetooth profile and “PhoneApp” does not answer the call; [7] gateway “answers” the secondary incoming cellular call; [8] cellular network disconnects the primary call with the “PhoneApp”; [9] the call is established between gateway and cellular network whereby the gateway forwards the voice data from cellular network to “PhoneApp” over Bluetooth and vice versa; [10] user decides to terminate the call and presses the “Hang OFF button”; [11] the “PhoneApp” sends a “Disconnect Call” command to gateway via Bluetooth profile; [12] gateway terminates the cellular secondary call.

Although the present invention has been described with reference to specific embodiments, this description is not meant to be construed in a limited sense. Various modifications of the disclosed embodiments, as well as alternative embodiments of the invention will become apparent to persons skilled in the art upon the reference to the description of the invention. It is, therefore, contemplated that the appended claims will cover such modifications that fall within the scope of the invention.

1-50. (canceled)

51. A multi frequency signal repeater system for various wireless applications, consisting:
(i) at least one amplifier;
(ii) a first group of antennas; and
(iii) a second group of antennas
while at least one antenna in each group having the same spectrum and corresponding to at least one antenna in the other group,
at least one antenna of said first group of antennas is directly connected to the input of the at least one amplifier, and at least one antenna of the second group of antennas is directly connected to the output of the at least one amplifier; and
wherein signals emitted from at least one antenna of the second group of antennas are received by at least one antenna of the first group of antennas and provide a dominant negative feedback to the amplifier.

52. The repeater system of claim 51, wherein the at least one amplifier is an operational amplifier.

53. The repeater system of claim 51, wherein each antennas group includes several antennas each operating at a different spectrum.

54. The repeater system of claim 51, wherein said spectrum is 0.7 GHz to 18 GHz.

55. The repeater system of claim 51, wherein at least one antenna of the second group of antennas is connected to the output of the amplifier through a phase shifting component.

56. The repeater system of claim 55, wherein said phase shifting component is controllable by a controlling means.

57. The repeater system of claim 51, wherein the first and second groups of antennas have opposite polarization.

58. The repeater system of claim 51, wherein the correspondence of same-spectrum antennas between the said two groups of antennas is characterized by having the distance between said corresponding antennas set to substantially provide a desired phase shift between the signals emitted by antennas from the first and second groups of antennas.

59. The repeater system of claim 51 wherein a plurality of said repeater systems having intercommunication capabilities among themselves, can communicate together with multiple mobile transceiver devices and multiple base transceiver stations.

60. The repeater system of claim 51, wherein a signal received by the at least one antenna of the first group is configured to be amplified by the at least one amplifier and be transmitted using the at least one antenna in the second group.

61. The repeater system of claim 51, consisting of at least two amplifiers conjoined in bidirectional positioning and configured to broadcast incoming and outgoing signals.

62. At least two repeater systems of claim 51 correspondingly installed in order to receive and transmit RF radiation in different directions.

63. A method for reducing cellular radiation in proximity of a user, consisting the steps of:
(i) using a multi frequency signal repeater system having at least one amplifier, a first group of antennas and a second group of antennas;
(ii) receiving signals transmitted by an end-user's transceiver device by at least one antenna of the first group of said repeater system;
(iii) transmitting signals from at least one antenna of second group of said repeater system;
(iv) providing a dominant negative-feedback to the at least one amplifier of said repeater system;
whereby radiation emitted from end-user's transceiver is a fraction of the radiation emitted from the second group of said repeater system.

64. The method of claim 63, wherein the at least one amplifier is an operational amplifier.

65. The method of claim 63, wherein the at least one amplifier is a non inverting amplifier and both input and output antenna radiate signals with opposite polarities or the same polarities.

66. The method of claim 63, wherein the at least one input and output antennas are operating at one single frequency band.

67. The method of claim 63, wherein at least two input antennas operating at different bandwidth.

68. The method of claim 63, wherein at least two output antennas operating at different bandwidth.

69. The method of claim 66, wherein the correspondence of same bandwidth antennas between said output and input antennas is that the distance between said corresponding antennas substantially equals the value of the desired phase shift between the at least one input and output antennas.

70. A method for reducing high-gain cellular radiation in proximity to a user, implemented by the incorporation of a dedicated software operating a dual SIM implemented in a repeater system and in a transceiver end-user device, consisting the steps of:
A. for an incoming call—
(i) identifying the occurrence of primary and secondary incoming calls from cellular network;
(ii) said dedicated software enabling receiving primary incoming call without completing it;
(iii) repeater receiving secondary incoming call without completing it;
(iv) end-user transceiver informs end-user of there being an incoming call;
(v) receiving end-user informed instruction to complete the incoming call;
(vi) secondary incoming call is connected between repeater and cellular network;
(vii) primary incoming call is disconnected by cellular network;
(viii) incoming call information is conveyed between repeater to end-user transceiver by low power wide area network means;
(ix) receiving end-user instruction to terminate the incoming call;
(x) incoming call termination instruction is conveyed to repeater;
(xi) repeater terminates the secondary incoming call communication with the cellular network.
B. for an outgoing call—
(i) receiving end-user instruction on end-user transceiver to initiate an outgoing call;
(ii) conveying to repeater instruction to connect to cellular network;
(iii) repeater connecting and communicating an outgoing call with the cellular network;
(iv) outgoing call information is conveyed between repeater to end-user transceiver by low power wide area network means;
(v) receiving end-user instruction to terminate the incoming call;
(vi) outgoing call termination instruction is conveyed to repeater;
(vii) repeater terminates the outgoing call communication with the cellular network.
